(19) United States
(12) Patent Application Publication
(10) Pub. No.: US 2002/0073087 A1
(43) Pub. Date: Jun. 13, 2002

(54) Input/output device for a data processing apparatus

(76) Inventor: Volkmar Bilke, Salzkotten (DE)

Correspondence Address: BELL, BOYD & LLOYD, LLC, P. O. BOX 1135, CHICAGO, IL, 60690-1135, US

(21) Appl. No.: 09/911,957

(22) Filed: Jul. 24, 2001

(30) Foreign Application Priority Data
Jul. 24, 2000 (DE) 100 35 964.7

(51) Int. Cl. G06F 7/00

(52) U.S. Cl. 707/10

(57) ABSTRACT

An input and output device having at least one display and a keyboard and, optionally, further input and output elements, such as a microphone, a loudspeaker, a camera, devices for coupling external appliances and/or a pointing device. The device is designed to be portable and can use an air interface for wirelessly accessing the processing capacity or computational power of a fixed data processing apparatus, for example of a PC, and the components thereof.

### BACKGROUND OF THE INVENTION

1. Field of the Invention

The present invention relates to an input/output device for a data processing apparatus, wherein the input/output device is separate and apart from such data processing apparatus and can communicate therewith via an air interface.

2. Description of the Prior Art

In a large number of private households, typical inexpensive data processing apparatuses used are “personal computers” (PC for short) for work, play and communication media. The PC with its components, such as printer or Internet access, is typically permanently installed at a point in the household, frequently in a remote room or even in the cellar. Use is therefore restricted to this location in the household.

By contrast, location-independent and mobile use is enabled by portable computers, such as “laptops” or “handheld appliances” which, however, generally provide only a restricted computational power as compared with a PC. Since the costs for a laptop having comparable processing power are significantly higher than for a fixed PC, private households usually use only fixed PCs anyway.

However, in view of the multifarious opportunities for use of a fixed data processing apparatus in a private household, location-independent or mobile use would be desirable in the whole area of the private household, if possible.

The present invention is, therefore, directed to providing an opportunity to be able to use a fixed data processing apparatus inexpensively and independently of location.

### SUMMARY OF THE INVENTION

The present invention is based on the idea of providing a portable input and output device which the user can use to access the computational power of a fixed data processing apparatus, such as a fixed personal computer, and the components thereof without needing to provide measures for a greater processing capacity or computational power in the portable input and output device itself.

Accordingly, in more convenient versions, the portable input and output device can have a microphone, a loudspeaker, a camera, connection sockets for external audio and video appliances for inputting and outputting video and audio signals and/or a pointing device, a mouse control or the like.

The inventive portable input and output device easily can be integrated into an existing fixed data processing apparatus; namely, by simply adding an air interface and a wireless or cordless data transmission link, such as by using an infrared, ultrasound and/or radio channel. The portable input and output device permits the use of all terminals and interfaces, e.g., for an Internet access, connected to the fixed data processing apparatus and of the programs implemented on the fixed data processing apparatus in mobile fashion in the air interface's entire coverage area.

Use, that is to say access to the fixed data processing apparatus, therefore can be effected at the user's desired location within a household; e.g., Internet in the living room, cookbook in the kitchen, garden adviser outdoors, music (MPEG3) on the stereo system, etc. In the case indicated, the coverage area also may include a terrace, a balcony or a garden. The fixed data processing apparatus, such as a fixed PC, in particular, continues to be available as a work appliance on which all hardware and software extensions and changes can be implemented.

Additional features and advantages of the present invention are described in, and will be apparent from, the following Detailed Description of the Preferred Embodiments and the Drawings.

### DESCRIPTION OF THE DRAWINGS

FIG. 1 shows an exemplary embodiment of the portable input and output device of the present invention.

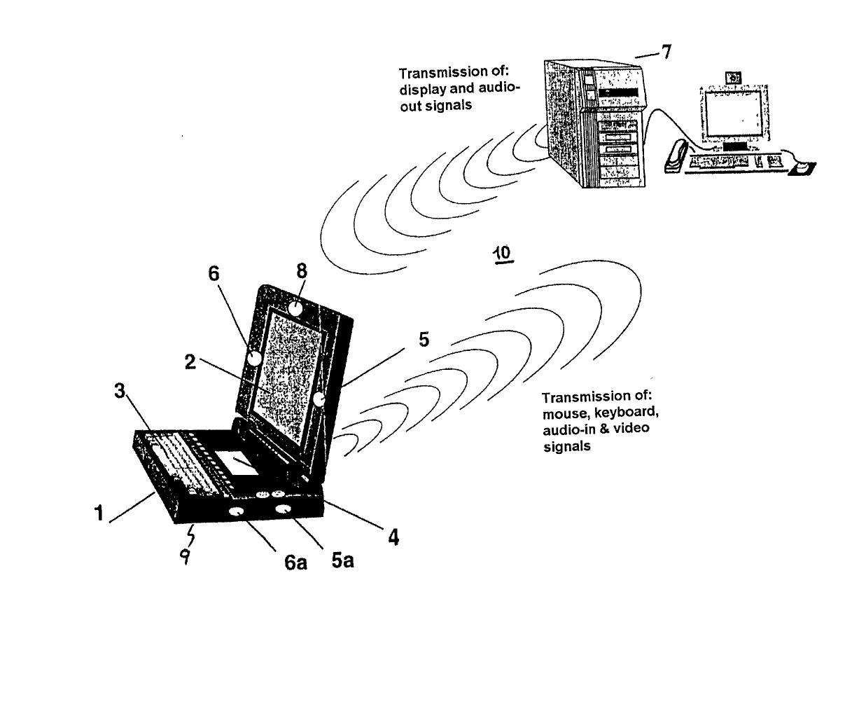

### DETAILED DESCRIPTION OF THE PREFERRED EMBODIMENTS

The input and output device 1 in accordance with the present invention has a display 2 and a keyboard 3, in this case a standard keyboard, as minimum equipment in a portable housing 9. In addition, the input and output device 1 shown contains a pointing device 4, a microphone 5 (mono or stereo), a loudspeaker 6 (mono or stereo), a camera 8 (analog or digital) and connection sockets 5a, 6a for connecting external audio and video appliances. Connection options for (external) scanners, printers, USB interfaces or the like also can be provided. An air interface 10 is used to set up a data transmission link between the portable input and output device 1 and a fixed data processing apparatus 7; in particular, a personal computer (PC). The signals transmitted from the portable input and output device 1 to the fixed data processing apparatus 7 via the air interface 10, which in this case is formed by a radio-electric transmission link, contain control functions and data inputs which have been input using the keyboard 3, the pointing device 4 and, possibly, a mouse control (not shown), the microphone 5, the camera 8 or the audio/video input connection socket 5a. The display 2, the loudspeaker 6 and the audio/video output connection socket 6a are used to output the data signals, image signals and audio signals received from the fixed data processing apparatus 7.

The portable input and output device 1 is thus used only for inputting or outputting data, information and control functions into or from the fixed data processing apparatus 7. The computational power is provided exclusively by the fixed data processing apparatus 7, which is why the portable input and output device 1 can be of very compact design and can be produced inexpensively. The air interface 10 also can be other transmission links or channels which can be used to transmit signals wirelessly or cordlessly, such as infrared or ultrasound transmission links.

The keyboard 3 also can be of very simple design, such as is customary for telephones, for example. However, the time needed to connect to the fixed data processing apparatus 7 is then increased. It is, therefore, expedient to use a standard keyboard. In the same way, it may be sufficient for the display 2 to be designed to have very small dimensions, but the process of reading is then more complicated and takes up more time.

Another advantageous application is provided if appliances and systems in the private household area can be controlled using the fixed data processing apparatus 7 (e.g., using HES, Home Electronic System, on the basis of the installation bus instabus EIB). The inventively portable input and output device can be integrated therein in this case, too. Provided that such household appliances and systems in the private household area have a two-way communication link to the fixed data processing apparatus 7, the input and output device 1 can be physically coupled there as well.

Use of the inventively portable input and output device is not limited to the private sector. It may be used wherever location-independent data and information transmission is desirable in addition to an already existing fixed data processing apparatus, such as a PC.

Although the present invention has been described with reference to specific embodiments, those of skill in the art will recognize that changes may be made thereto without departing from the spirit and scope of the invention as set forth in the hereafter appended claims.

I claim as my invention:

1. A portable input and output device for accessing a data processing apparatus, which is separate from the input and output device, via an air interface, the device comprising:
at least one input apparatus for inputting information to be transmitted via the air interface;
at least one output apparatus for outputting information received via the air interface; and
an internal processing part only for inputting and outputting information on the input and output device and for transferring information using the data processing apparatus.

2. A portable input and output device for accessing a data processing apparatus as claimed in claim 1, wherein the data processing apparatus is a personal computer.

3. A portable input and output device for accessing a data processing apparatus as claimed in claim 1, wherein the at least one input apparatus is a keyboard and the at least one output apparatus is a display.

4. A portable input and output device for accessing a data processing apparatus as claimed in claim 1, further comprising:
a microphone and a loud speaker for inputting and outputting at least one of voice, sound and audio signals.

5. A portable input and output device for accessing a data processing apparatus as claimed in claim 1, further comprising:
a camera for inputting image signals.

6. A portable input and output device for accessing a data processing apparatus as claimed in claim 1, further comprising:
a device for inputting and outputting audio and video signals from and to external audio and video appliances.

7. A portable input and output device for accessing a data processing apparatus as claimed in claim 1, further comprising:
a mouse controller.

8. A portable input and output device for accessing a data processing apparatus as claimed in claim 1, wherein the air interface is formed by one of an infrared transmission link, an ultrasound transmission link and a radio-electric transmission link.
